(19) United States
(12) Patent Application Publication
(10) Pub. No.: US 2020/0375828 A1
(43) Pub. Date: Dec. 3, 2020

(54) PATIENT SUPPORT INTERFACE DEVICE

(71) Applicant: Hill-Rom Services, Inc., Batesville, IN (US)

(72) Inventors: Neal Wiggermann, Batesville, IN (US); Xuan Teng, Batesville, IN (US)

(21) Appl. No.: 16/887,131

(22) Filed: May 29, 2020

Related U.S. Application Data
(60) Provisional application No. 62/854,665, filed on May 30, 2019.

(51) Int. Cl. A61G 7/05; A61G 7/015; A61G 7/16; A61G 7/075; A61G 7/07; A61G 7/018

(52) U.S. Cl. CPC A61G 7/0524; A61G 7/015; A61G 7/16; A61G 2203/12; A61G 7/072; A61G 7/018; A61G 7/0755

(57) ABSTRACT

A patient bed includes an interface device having buttons for positioning the patient bed to accommodate a patient's body. The buttons can be illuminated, and can be responsively dimmed when the patient bed reaches movement thresholds to communicate to the user that further movement according to the particular button is discouraged and/or unavailable.

### CROSS-REFERENCE TO RELATED APPLICATIONS

The present application claims the benefit of priority to U.S. Provisional Patent Application No. 62/854,665, entitled “PATIENT SUPPORT INTERFACE DEVICE,” filed on May 30, 2019, the contents of which are incorporated by reference herein in their entirety, including but not limited to those portions concerning patient support and/or related devices, systems, and methods.

### BACKGROUND

The present disclosure relates to devices, systems, and methods for patient supports. More specifically, the present disclosure relates to devices, systems, and methods for interfacing with patient supports.

Patient supports, such as patient beds of care facilities, can offer a variety of user inputs to conduct control operations and/or otherwise provide access to faculties of the patient's environment. However, with increasing number and complexity of input options, users can become confused regarding the manner and extent of inputs. Simple and/or intelligent interface options can reduce user confusion and/or encourage desirable user inputs which can assist in effective care solutions.

### SUMMARY

The present application discloses one or more of the features recited in the appended claims and/or the following features which, alone or in any combination, may comprise patentable subject matter.

According to an aspect of the present disclosure, a patient bed or support may comprise a bed frame for supporting a patient above the floor. The bed frame may include a deck including head, knee, and/or foot portions for supporting corresponding portions of the patient's body. The deck may be selectively positionable to accommodate positioning of the patient's body. The patient bed may include a control system which may include at least one actuator coupled with the bed frame for selectively positioning the deck according to user selection. The patient bed may include an interface device arranged in communication with the control system to provide selective positioning of the deck. The interface device may include a number of buttons for user selection to selectively position the deck, and at least one light source for illuminating the number of buttons. The at least one light source may be configured to darken selective ones of the number of buttons responsive to the position of the deck reaching at least one predetermined threshold.

In some embodiments, the at least one of the head, knee, and/or foot portions of the deck may be positionable between maximum and minimum positions. The at least one predetermined threshold may include the maximum position of at least one of the head, knee, and/or foot sections of the deck. In some embodiments, at the maximum position of the at least one of the head, knee, and/or foot sections of the deck, the at least one light source may darken at least one of the number of buttons which corresponds to adjustment of the at least one of the head, knee, and/or foot portions of the deck in a direction beyond the maximum position.

In some embodiments, the at least one light source may be configured to illuminate the at least one darkened button responsive to the position of the at least one of the head, knee, and/or foot portions of the deck being arranged at a position less than the maximum. Illuminating the at least one button may include revealing the at least one button. Darkening the at least one button may include hiding the at least one button.

In some embodiments, the at least one predetermined threshold may include the minimum position of at least one of the head, knee, and/or foot sections of the deck. At the minimum position of the at least one of the head, knee, and/or foot sections of the deck, the at least one light source may darken at least one of the number of buttons which corresponds to adjustment of the at least one of the head, knee, and/or foot portions of the deck in a direction below the minimum position. The at least one light source may be configured to illuminate the at least one darkened button responsive to the position of the at least one of the head, knee, and/or foot portions of the deck being arranged at a position greater than the minimum position. In some embodiments, illuminating the at least one button may include revealing the at least one button. In some embodiments, darkening the at least one button includes hiding the at least one button.

In some embodiments, the at least one predetermined threshold may be set according to the patient's care regime. The at least one predetermined threshold may be set to include a preset angle of inclination of the head portion of the deck such that responsive to the head portion reaching at least the preset angle of inclination of the head portion, the light source may darken the one of the buttons corresponding to increasing head portion inclination. The preset angle of inclination may be an upper limit that is set according to the patient's care regime, and/or responsive to positioning of the head portion at least at the preset angle of inclination of the head portion, the at least one light source may pulse the one of the buttons corresponding to decreasing head portion inclination, to suggest lowering of the inclination of the head portion.

In some embodiments, the preset angle of inclination may be a lower angle set according to the patient's care regime, and/or responsive to positioning of the head portion at least at the preset angle of inclination of the head portion, the at least one light source may pulse the one of the buttons corresponding to increasing head portion inclination, to suggest raising of the inclination of the head portion.

In some embodiments, the predetermined threshold may include at least one of a lower and an upper deck height. At least one of the lower and the upper deck height may be a recommended threshold set according to the patient's care regime. In some embodiments, responsive to positioning of the deck at least at the upper deck height, the at least one light source may darken at least one button which corresponds to increase of the deck height. In some embodiments, responsive to positioning of the deck at least at the upper deck height, the at least one light source may pulse at least one button which corresponds to decrease the deck height, to suggest returning the deck to a position below the upper deck height.

In some embodiments, the predetermined threshold may include at least one of a lower and an upper foot portion height. At least one of the lower and the upper foot portion height may be a recommended threshold set according to the patient's care regime. In some embodiments, responsive to positioning of the foot portion at least at the upper foot portion, the at least one light source may darken at least one button which corresponds to increase of the foot portion height. In some embodiments, responsive to positioning of the foot portion at least at the upper foot portion height, the at least one light source may pulse at least one button which corresponds to decrease the foot portion height, to suggest returning the foot portion to a position below the upper foot portion height.

In some embodiments, responsive to positioning of the foot portion at least at the lower foot portion, the at least one light source may darken at least one button which corresponds to decrease of the foot portion height. In some embodiments, responsive to positioning of the foot portion at least at the lower foot portion height, the at least one light source may pulse at least one button which corresponds to increase of the foot portion height, to suggest returning the foot portion to a position above the lower foot portion height.

In some embodiments, the patient bed or support may include a mattress supported on the deck for interface with the patient's body. The mattress may include at least one pressurizable chamber for receiving pressurized fluid. The predetermined threshold may include at least one of an upper and lower mattress pressure. The number of buttons may include buttons for increasing and decreasing the mattress pressure.

In some embodiments, the responsive to the mattress pressure being at least at the upper mattress pressure, the at least one light source may darken at least one button which corresponds to increase of the mattress pressure. In some embodiments, responsive to the mattress pressure being at least at the upper mattress pressure, the at least one light source may pulse at least one of the number of buttons which corresponds to decrease of the mattress pressure, to suggest returning the mattress pressure below the upper mattress pressure.

In some embodiments, responsive to the mattress pressure being at least at the lower mattress pressure, the at least one light source may darken at least one button which corresponds to decrease of the mattress pressure. Responsive to the mattress pressure being at least at the lower mattress pressure, the at least one light source may pulse at least one of the number of buttons which corresponds to decrease of the mattress pressure, to suggest returning the mattress pressure above the lower mattress pressure.

In some embodiments, the interface device may include a bed pendant. In some embodiments, the interface device may include a side rail control panel. The interface device may include an interface panel having the number of buttons disposed on the interface panel. The at least one light source may be arranged within the interface panel to backlight the buttons.

In some embodiments, the at least one light source may include light emitting diodes. The at least one light source may include one light emitting element for each of the number of buttons. In some embodiments, darkening selective ones of the number of buttons includes changing color of illumination of the selective ones.

In some embodiments, the at least one light source may be configured to deadfront at least one of the number of buttons responsive to the deck position reaching at least one predetermined threshold. Deadfronting of one of the buttons may include reducing lighting of a face of the one of the buttons to reduce button visibility. Reducing visibility may include hiding the face of the one of the buttons, and/or removing backlighting of the one of the buttons, and/or de-illuminating translucent portions of the face of the one of the buttons to render the one of the buttons substantially invisible.

Accordingly to another aspect of the present disclosure, an interface system for providing selective positioning of a patient bed (or support) may comprise an interface device including a number of buttons disposed on an interface panel for selection to selectively position the patient bed. The interface system may include a controller for sending user input signals to the patient bed and for receiving communication of a position of the patient bed. The controller may be arranged to determine that the patient bed has reached a limit position based on the received communication and for providing a control signal indicating that the patient bed has reached a limit position. The interface system may include at least one light source for illuminating the number of buttons. The at least one light source may be configured to darken selective ones of the number of buttons based on the control signal.

In some embodiments, the number of buttons may include increase and decrease buttons corresponding to increase and decrease in the position of one or more of a head, knee, and/or foot portions of the deck of the patient bed. The limit position may include a positional limitation of one of the head, knee, and foot portions of the deck, and the at least one light source darkens at least one of the number of buttons which corresponds to adjustment of the one of the head, knee, and/or foot portions of the deck in a direction beyond the limit position. The at least one light source may be configured to illuminate the at least one darkened button responsive to the at least one of the head, knee, and/or foot portions of the deck assuming a position within the limit position.

In some embodiments, illuminating the at least one darkened button may include revealing the at least one button. Darkening the at least one button may include hiding the at least one button. In some embodiments, the limit position may include at least one predetermined threshold set according to the patient's care regime. The at least one predetermined threshold may be set to include a preset angle of inclination of a head portion of the patient bed such that responsive to the head portion reaching at least the preset angle of inclination of the head portion, the at least one light source may darken the one of the buttons corresponding to increasing head portion inclination.

In some embodiments, the preset angle of inclination may be an upper limit that is set according to the patient's care regime, and/or responsive to positioning of the head portion at least at the preset angle of inclination of the head portion, the at least one light source may pulse the one of the buttons corresponding to decreasing head portion inclination, to suggest lowering of the inclination of the head portion. The preset angle of inclination may be a lower angle set according to the patient's care regime, and/or responsive to positioning of the head portion at least at the preset angle of inclination of the head portion, the at least one light source may pulse the one of the buttons corresponding to increasing head portion inclination, to suggest raising of the inclination of the head portion.

In some embodiments, the at least one predetermined threshold may include at least one of a lower and an upper deck height of the patient bed. At least one of the lower and the upper deck height may be a recommended threshold set according to the patient's care regime. In some embodiments, responsive to positioning of the deck at least at the upper deck height, the at least one light source may darken at least one button which corresponds to increase of the deck height. In some embodiments, responsive to positioning of the deck at least at the upper deck height, the at least one light source may pulse at least one button which corresponds to decrease the deck height, to suggest returning the deck to a position below the upper deck height.

In some embodiments, the predetermined threshold may include at least one of a lower and an upper foot portion height. At least one of the lower and the upper foot portion height may be a recommended threshold set according to the patient's care regime. In some embodiments, the responsive to positioning of the foot portion at least at the upper foot portion, the at least one light source may darken at least one button which corresponds to increase of the foot portion height. In some embodiments, responsive to positioning of the foot portion at least at the upper foot portion height, the at least one light source may pulse at least one button which corresponds to decrease the foot portion height, to suggest returning the foot portion to a position below the upper foot portion height.

In some embodiments, responsive to positioning of the foot portion at least at the lower foot portion, the at least one light source may darken at least one button which corresponds to decrease of the foot portion height. In some embodiments, responsive to positioning of the foot portion at least at the lower foot portion height, the at least one light source may pulse at least one button which corresponds to increase of the foot portion height, to suggest returning the foot portion to a position above the lower foot portion height.

In some embodiments, the patient bed (or support) may comprise a mattress supported on a deck for interface with the patient's body. The mattress may include at least one pressurizable chamber for receiving pressurized fluid. In some embodiments, the predetermined threshold may include at least one of an upper and lower mattress pressure. The number of buttons may include buttons for increasing and/or decreasing the mattress pressure. In some embodiments, responsive to the mattress pressure being at least at the upper mattress pressure, the at least one light source may darken at least one button which corresponds to increase of the mattress pressure. In some embodiments, responsive to the mattress pressure being at least at the upper mattress pressure, the at least one light source may pulse at least one of the number of buttons which corresponds to decrease of the mattress pressure, to suggest returning the mattress pressure below the upper mattress pressure. In some embodiments, responsive to the mattress pressure being at least at the lower mattress pressure, the at least one light source may darken at least one button which corresponds to decrease of the mattress pressure. In some embodiments, the responsive to the mattress pressure being at least at the lower mattress pressure, the at least one light source pulses at least one of the number of buttons which corresponds to decrease of the mattress pressure, to suggest returning the mattress pressure above the lower mattress pressure.

In some embodiments, the interface device may be formed as a bed (or support) pendant. The interface device may include a side rail control panel. The interface device may include an interface panel having the number of buttons disposed on the interface panel. The at least one light source may be arranged within the interface panel to backlight the buttons.

In some embodiments, the at least one light source may include light emitting diodes. The at least one light source may include one light emitting element for each of the number of buttons. In some embodiments, darkening selective ones of the number of buttons may include changing color of illumination of the selective ones.

According to another aspect of the present disclosure, a user interface for a patient support may comprise a housing, and a number of buttons arranged on the housing for user selection. User selection of each of the buttons may activate a corresponding care feature. Each corresponding care feature may be assigned to an operation of one of the patient support and a patient room to which the patient support is allocated. In some embodiments, each of the buttons may be configured to be deadfronted when the corresponding care feature is unavailable.

In some embodiments, the buttons being configured to be deadfronted may include at least one button having corresponding care feature including patient support deck control. The corresponding care feature of the at least one button may include patient support deck position adjustment. The buttons being configured to be deadfronted may include at least one button having corresponding care feature including air mattress control. The corresponding care feature of the at least one button may include air mattress pressure control.

In some embodiments, the buttons being configured to be deadfronted may include at least one button having corresponding care feature including television control. The corresponding care feature of the at least one button may include volume control of a television of the patient room to which the patient support is allocated. Configuration of one of the buttons to be deadfronted may include reducing lighting of a face of the one of the buttons to reduce button visibility.

In some embodiments, reducing visibility may include hiding the face of the one of the buttons. Reducing visibility may include removing backlighting of the one of the buttons. Reducing visibility may include de-illuminating translucent portions of the face of the one of the buttons to render the one of the buttons substantially invisible.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a patient bed arranged to incline a head section to sit the patient partly up, the patient bed including a user interface for receiving user inputs including user inputs to operate bed features, such as the angle of incline of the head section of the deck of the patient bed;

FIG. 2 is an elevation view of the patient bed of FIG. 1 showing that the head section has been arranged in an inclined position having a maximum angle of incline as shown in solid line, and indicating a flat position of the head section, which can represent a minimum angle of incline as shown in broken line;

FIG. 3 is a partial diagrammatic view of a control system of the patient bed of FIGS. 1 and 2, showing that the control system includes various actuators and sensors for performing patient bed operations, such as a motors for selectively positioning the deck of the patient bed, and showing that the control system is in communication with the user interface to receive user inputs and to selectively illuminate buttons of the user interface based on the conditions of the patient bed, such as the position of the patient bed;

FIG. 4 is a perspective view of the patient bed of FIGS. 1 and 2, having an enlarged view of the user interface, showing that the buttons of the user interface include bed position deck buttons for adjusting the head, knee, and foot sections of the deck between upper and lower positions (such as the maximum and minimum incline positions of the head section as shown in FIG. 2), and includes mattress buttons for inflating and deflating the mattress of the bed between maximum and minimum pressures, and showing that the deck buttons and the mattress buttons are fully illuminated to indicate that user selection of those buttons is available to operate the patient bed;

FIG. 5 is an elevation view of the patient bed of FIGS. 1, 2, and 4, having the enlarged view of the user interface as in FIG. 4, but showing that the head section of the deck has been inclined to the maximum incline position such that further inclining of the head section is unavailable, and showing that the deck button corresponding to increase the incline of the head section of the deck has been darkened (as represented in broken line in FIG. 5) to indicate that its selection for operation to further incline the position of the head section is presently unavailable;

FIG. 6 is a front view of the user interface of the patient bed of FIGS. 1, 2, 4, and 5 showing that additional buttons have been darkened to indicate their unavailability for selection, such as the mattress buttons, and various room control buttons; and

FIG. 7 is a perspective view of the patient bed similar to FIG. 4, having an enlarged view of the user interface, showing that the head section is partially inclined and that the incline button of the user interface is pulsing (as represented with emphasis lines in FIG. 7) indicating that the patient's care regime has been set to prefer a more inclined position to encourage the user to further incline the head section of the patient bed.

### DETAILED DESCRIPTION

For the purposes of promoting an understanding of the principles of the disclosure, reference will now be made to a number of illustrative embodiments illustrated in the drawings and specific language will be used to describe the same.

Patient supports, such as patient beds, can provide appropriate support platforms for patient care. Patient supports can include a variety of adjustable features to allow selective arrangement of the support to accommodate the patient's body in a desirable manner. For example, adjusting the inclination of the patient's torso can provide desirable positioning for comfort of the patient, for accessibility of the patient's body to care givers and/or equipment, and/or for providing desirable positioning of the patient's body for therapy and/or healing such as to encourage upper respiratory drainage, to reduce the risk of pressure ulcers on the sacrum, and/or to reduce the risk of ischial tuberosities.

In order to configure the patient support, the patient and/or any user, may have access to a control interface arranged to manipulate the patient support. However, presenting the user with too many options for manipulation of the patient support can create confusion. Moreover, providing the user with options for manipulation of the patient support which are unavailable and/or undesirable for a given patient may encourage errant and/or undesirable positioning of the patient support. Accordingly, reducing unavailable operations from the user's attention can enhance the user experience and/or improve the human-machine interface.

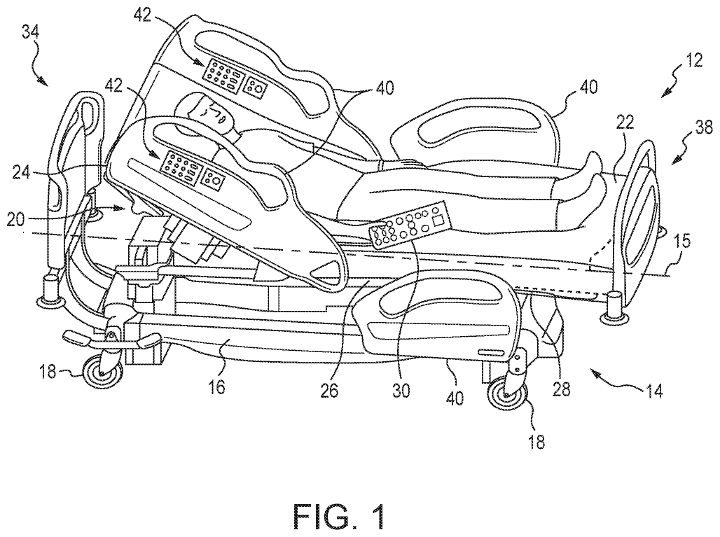

In the illustrative embodiment as shown in FIG. 1, a patient support 12 is shown embodied as a patient bed in a care facility, such as a hospital. The patient support 12 includes a frame 14 having a base 16 supported by wheels 18, and a deck 20 supported by the base 16. The deck 20 illustratively supports a mattress 22 for engaging the patient's body. The deck 20 extends along a longitudinal axis 15 and is adjustably supported by the base 16 to provide selective positioning along the axis 15 to accommodate the patient's body.

The deck 20 illustratively includes a head portion 24, a knee (or seat) portion 26, and a foot portion 28 arranged in series from the head end 34 to the foot end 38 of the patient bed 12 to support the corresponding torso, knee, and foot areas of the patient's body. Each of the portions 24-28 are illustratively positionable to customize the arrangement of the deck 20, and the mattress 22 supported by the deck 20, to provide selective positioning of the patient's body. In some embodiments, one or more of the head portion 24, knee portion 26, and/or foot portion 28 may include sub-portions which are individually adjustable in position, for example, the knee portion 26 may include distinct gluteal and thigh sub-portions for individual positioning for support of the patient's body. The patient bed 12 includes an interface device 30, embodied as a pendant controller, coupled with the frame 14 for user operation to adjust the position of the deck 20.

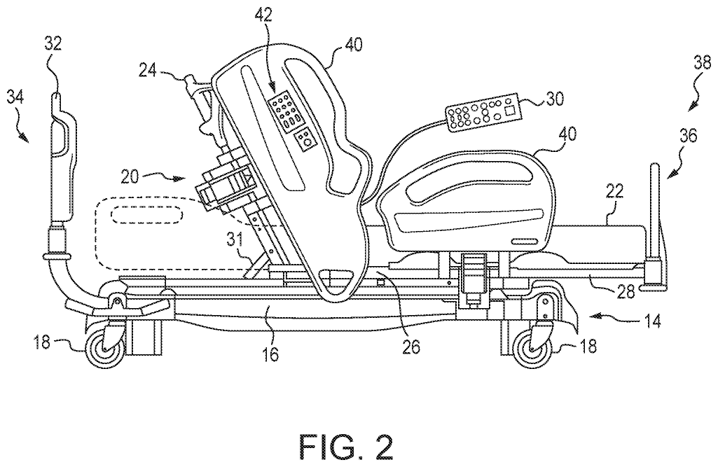

Referring now to FIG. 2, the head portion 24 of the deck has been arranged in an inclined position, represented in solid line, to incline an occupying patient's torso. A flat arrangement of the head portion 24 is shown in broken line in FIG. 2, to illustrate another possible configuration of the deck 20. The deck 20 is illustratively coupled with the base 16 via at least one actuator 31 for arranging the position of the deck 20 relative to the base 16. Accordingly, a user can adjust the position of the deck 20 by providing inputs via the interface device 30 to adjust individual portions 24-28 of the deck 20.

In some embodiments, the deck 20 may be coupled with the base 16 via any suitable number of actuators, and/or with mechanical linkages operated by the actuators 31 to position the head portion 24, knee portion 26, and/or foot portion 28, individually. For example, as discussed in additional detail hereafter, each of the head portion 24, knee portion 26, and/or foot portion 28 may each include at least one actuator 31 for individually positioning each portion. In some embodiments, mechanical linkages may be arranged to coordinate motion between the portions 24-28 such that position adjustment of one portion produces corresponding position adjustment of another portion.

In the illustrative embodiment as shown in FIG. 2, the base 16 includes a headboard 32 arranged at a head end 34 of the bed 12. The deck 20 includes a footboard 36 arranged at the foot end 38 and connected with the foot portion 28. A number of siderails 40 are coupled with the deck 20 along lateral sides of the bed 12 and can be selectively collapsed for access to the mattress area. The siderails 40 at the head end 34 may include interface devices 42, similar to interface device 30, coupled with the bed 12 for user selection to adjust the position of the deck 20.

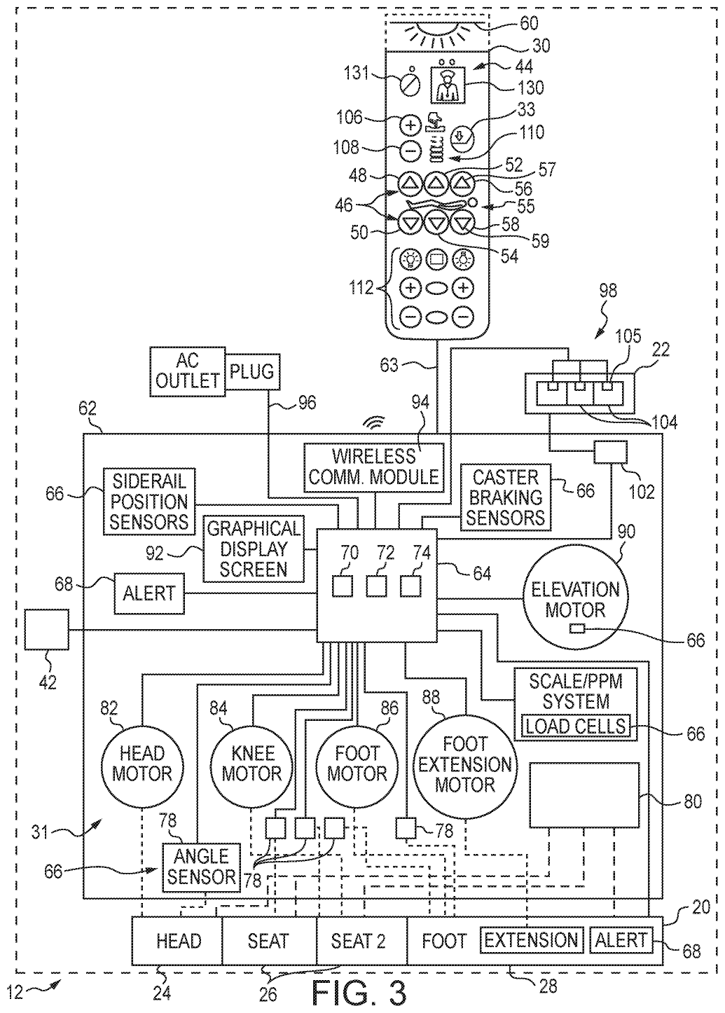

Referring to FIG. 3, the interface device 30 illustratively include an interface panel 44. The interface panel 44 includes buttons 46 for adjusting parameters of the patient bed 12. The buttons 46 include up 48 and down 50 foot buttons for selectively adjusting the foot portion 28 between upward and downward positions, respectively; up 52 and down 54 knee buttons for selectively adjusting the knee portion 26 between upward and downward positions, respectively; up 56 and down 58 head buttons for selectively adjusting the head portion 24 between upward and downward positions, respectively. A depiction 55 of a patient lying in supine position is presented on the interface panel 44 with the up buttons 48, 52, 56 arranged above the depiction 55 and the down buttons 50, 54, 56 arranged below the depiction 55, in corresponding lateral arrangement with the foot, knee, and head portions of the body of the patient in the depiction 55. In some embodiments, up and down buttons for increasing and decreasing the height of the entire deck 20 may be provided on one or more of the interface device 30 and the interface devices 42. Correspondence in the button arrangement with the depiction 55 can promote recognition of the associated button function.

In the illustrative embodiment, the buttons 52, 54 of the knee portion provide upward and downward control of the knee portion 26 of the deck 20, while the buttons 48, 50 and 56, 58 for the head and foot portions 24, 28 provide articulated positioning including inclining and declining of those portions 24, 28. Although the up and down buttons are discussed in terms of increase and decrease and/or upward and downward operation of the corresponding deck section, articulation may not require a perceptible change in height and may include merely angle adjustment, and the direction of movement of sections of the deck may have any suitable range of motion for accommodating patient and/or bed positioning, including, for example, compound movements having any of linear and/or angular motion. In some embodiments, the user interface 30 may be configured for any range of suitable position adjustments and corresponding buttons for the deck 20.

The interface device 30 includes a light source 60 for selectively illuminating the buttons 46. In the illustrative embodiment, the light source 60 itself is disposed within the interface device 30 behind the interface panel 44, hidden from view, although diagrammatically shown within a broken line box in FIG. 3 for purposes of illustration. The light source 60 is illustratively embodied as a number of light emitting diodes (LEDs), having one LED arranged as a backlight within the panel 44 for each button 46 for illuminating translucent portions of the button 46 for visual identification. For example, on the button face, the up buttons 48, 52, 56 include an upward directed arrowhead 57, and the down buttons 50, 54, 58 include a downward directed arrowhead 57. In the illustrative embodiment, the arrowheads 57, 59 are translucent such that backlighting by the light source 60 illuminates the particular arrowhead 57, 59 for display to the user. In some embodiments, portions of the buttons 46 other than the arrowheads 57, 59 may be translucent. The light source 60 is operable to selectively illuminate each button 46 to indicate the available functions of the buttons 46 according to the conditions of the patient bed 12, as discussed in additional detail below.

Referring still to FIG. 3, the interface device 30 is arranged in communication with a control system 62 of the patient bed 12 to communicate user inputs for adjusting bed parameters. The interface device 30 is illustratively connected with the control system 62 via communication line 63, embodied as a hardline, but in some embodiments may include a wireless communication line. The control system 62 is illustratively coupled with the frame 14 and includes a control device 64, actuators 31, sensors 66, and alerts 68 (e.g., lights and/or sound devices) for conducting patient bed 12 operations.

The control device 64 includes a processor 70, embodied as a microprocessor, a memory device 72 for storing instructions, and communications circuitry 74 for communicating with other elements of the control system 62. The processor 70 executes instructions stored on the memory device 72 based on information received via the communications circuitry 74, for example, from the sensors 66, and issues commands through the communications circuitry 74 to operate the patient bed 12. Examples of suitable memory storages, such as memory device 72, may include primary storage and/or non-primary storage (e.g., secondary, tertiary, etc. storage); may include permanent, semi-permanent, and/or temporary storage; and/or may include memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory.

The sensors 66 illustratively include angle sensors 78 for determining the angle of inclination of each of the head portion, knee, and foot portions 24, 26, 28 (including each sub-section of the knee portion 26), pressure sensors 105, and position sensors 80 for sensing the amount of extension of the foot portion 28 along the axis 15 to accommodate taller patient's and/or the amount of lateral extension of the portions 24-28 to accommodate bariatric patients. The sensors 66 illustratively include siderail position sensors 66, wheel castor brake sensors 66, deck height sensors 66, load cells 66, and in some embodiments, may include any number and/or variety of sensors for sensing operational status of the bed 12. The sensors 66 communicate their sensed parameters to the control device 64 for determining operational status and/or for consideration in conducting bed operations.

In the illustrative embodiment as shown in FIG. 3, the actuators 31 include a head motor 82, knee motor 84, foot motor 86, and foot extension motor 88 for actuation to position the corresponding portion of the deck 20 according to commands from the control device 64. The control device 64 communicates to operate each of the motors 82, 84, 86, 88 as appropriate in coordination with each other according to the user inputs received from the interface device 30. The actuators 31 include an elevator motor 90 for raising and lowering the entire deck 20 as directed by the control device 64.

In the illustrative embodiment, via the control device 64, the head and foot motors 82, 86 are operated individually by the corresponding buttons 48, 50 and 56, 58, while the knee motor 84 operates in coordinated movement with the other portions 24, 28 when the deck 20 reaches appropriate positions. For example, upon lowering the foot portion 28, the knee motor 84 can be operated in coordination to move the knee portion 26 in correspondence with the movement of the foot portion 28. The elevator motor 90 is operated individually by the corresponding buttons 52, 54. Suitable examples of bed infrastructure for movement of the deck of the patient bed 12 are disclosed within U.S. Patent Application Publication Nos. 2010/0122415, published on May 20, 2010; 2012/0005832, published on Jan. 12, 2012; 2014/0082849, published on Mar. 27, 2014; 2015/0157521, published on Jun. 11, 2015, and 2018/0161225, published on Jun. 14, 2018, each of which are incorporated by reference herein, in their entirety, including at least those portions related to patient support operation and movement.

The control system 62 can receive other user inputs from other devices, such as the interface devices 42, and illustratively includes a display screen 92 for graphical display, and wireless communication module 94 for wireless communications, for example, with other devices and/or system of the care facility. The patient bed 12 includes an electrical power cord 96 connected with the control system 62 to provide electrical power to the patient bed 12, for example, from a wall outlet of the care facility, and can include onboard power storage for temporary electrical power supply.

Referring still to FIG. 3, the patient bed 12 illustratively includes a pressurized fluid system 98 in communication with the control system 62 for providing pressurized fluid for pressurizing the mattress 22. The pressurized fluid system 98 includes a compressor 102 connected by fluid transport conduit with the mattress 22 to provide pressurized fluid, such as air, to pressurize bolsters 104 of the mattress 22. The pressurized fluid system 98 includes pressure sensors 105 disposed in the mattress 22, e.g., within the bolsters 104, for detecting the pressure therein for communication to the control device 64. The control device 62 provides commands to the compressor 102 and its accessories to provide selective pressurization of the mattress 22 according to the user inputs.

The pressurized fluid system 98 illustratively includes conduit, valves, and/or other pressurized fluid handling accessories for providing adjustable mattress pressure. Examples of suitable pressurized fluid system infrastructure are disclosed within U.S. Patent Application Publication Nos. 2010/0122415, published on May 20, 2010; 2012/0005832, published on Jan. 12, 2012; 2014/0082849, published on Mar. 27, 2014; 2015/0157521, published on Jun. 11, 2015, and 2018/0161225, published on Jun. 14, 2018, each of which is incorporated by reference herein, in its entirety, and including at least those portions related to patient supports and/or pressurized fluid operation.

The interface device 30 includes increase 106 and decrease 108 buttons for receiving user input to increase or decrease mattress pressure, respectively. The light source 60 is illustratively embodied to have one light arranged as a backlight for each buttons 106, 108 for illuminating translucent portions of the buttons 106,108 for visual identification. The entirety of the buttons 106, 108 are embodied as translucent except for their corresponding plus or minus sign which is not translucent or significantly less translucent than the remainder of the button so that the sign is visible upon illumination of the button.

The interface device 30 includes a pressure indicator 110 embodied as a bar graph. The pressure indicator 110 includes a number of lights of the light source 60 arranged serially for selective illumination to indicate the incremental percentage of pressure from 0 to 100% within the mattress 22. The interface device 30 communicates the user inputs received via the buttons 46, 106, 108 of the interface panel 44 to the control device 64 for appropriate operation.

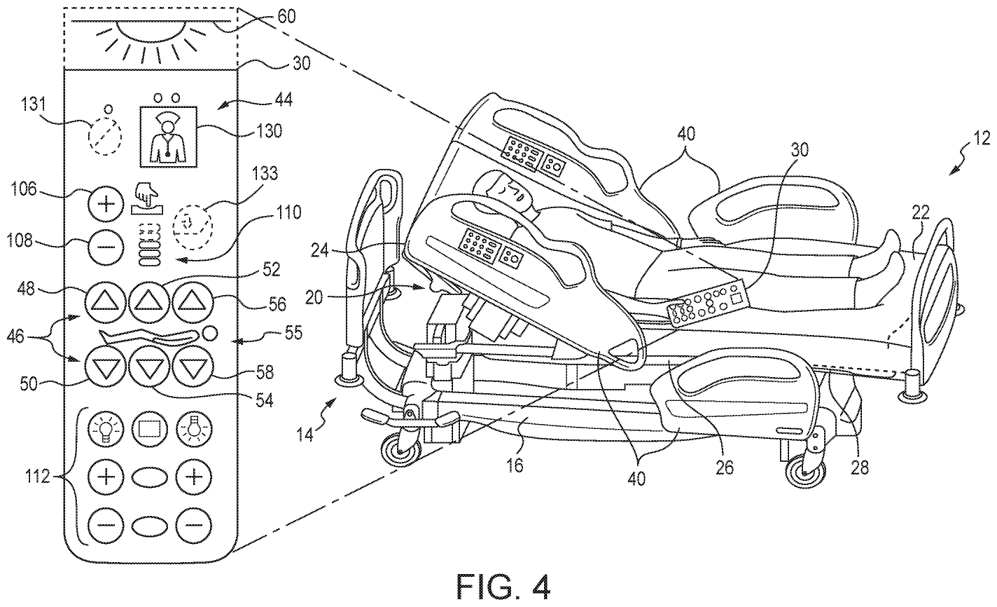

Referring now to FIG. 4, the interface device 30 can selectively darken individual buttons 46 according to the operational state of the patient bed 12. As shown in FIG. 4, each of the buttons 46 are illuminated indicating to the user that the associated operations of each of the buttons 46 is available. Notably, the patient bed 12 on the right side in FIG. 4 is shown in a generally flat arrangement although the head portion 24 of the deck 20 is partly inclined to a position less than a maximum inline. As the deck 20 is arranged with each portion 24-28 arranged within a middle of operable extent, having no portions 24-28 positioned at their maximum or minimum extent, each of the buttons 46 remains illuminated.

More specifically, the buttons 46 remain brightly illuminated to indicate to the user that additional operation of the corresponding function for each button 46 is presently available. For example, the head portion 24 of the deck 20 can be inclined or declined from its current position by pressing the corresponding button 58, 56. In the illustrative embodiment, the control device 64 determines whether a bed feature is at a maximum or minimum extent based on the information received from one or more sensors 66, 78, 80, 105 and communicates with the interface device 30 to illuminate and de-luminate the buttons 46, 106, 108 as appropriate based on the determination.

As shown in FIG. 4, the buttons 106, 108 are illuminated, indicating to the user that additional operation of the corresponding function for each button 106, 108 is presently available. In the illustrative embodiment, the illumination of each button 106, 108 indicates to the user that the mattress pressure can be adjusted by each button 106, 108. More specifically, the buttons 106, 108 remain brightly illuminated indicating that the mattress pressure is between maximum and minimum settings, and that the user can presently activate each of the buttons 106, 108 to increase or decrease mattress pressure, respectively.

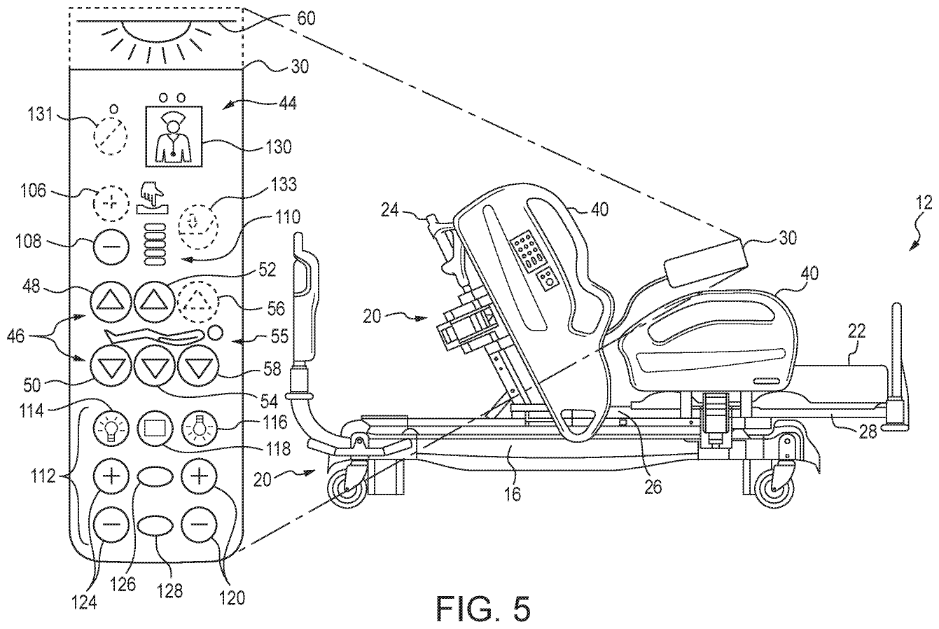

Referring now to FIG. 5, the patient bed 12 on the right side in FIG. 5 is shown in an arrangement in which the knee and foot portions 26, 28 are generally flat, but the head portion 24 of the deck 20 is in a fully inclined position, which represents a maximum incline for the head portion 24. As seen on the interface device 30, on the left side in FIG. 5, the button 58 is darkened (as represented by dashed line in FIG. 5) indicating to the user that further inclining of the head portion 24 is unavailable at the present time. The other buttons 50-56 remain illuminated, indicating that they can presently be operated as the deck 20 is not at a maximum or minimum extent with respect to their corresponding function.

Upon reduction of the inclination of the head portion 24 of the deck 20, the incline button 58 can be re-illuminated from its darkened state. Darkening buttons corresponding to unavailable operations presents a deadfront button having substantially reduced visibility indicating that the incline button 58 operation is unavailable. Deadfront buttons or buttons that have been deadfronted can be darkened or de-illuminated entirely such that the button is substantially invisible, for example, in low ambient light or dark room conditions. Accordingly, user confusion can be avoided as to available bed functions.

As seen on the interface device 30, on the left side in FIG. 5, the mattress pressure increase button 106 is darkened (as represented by dashed line in FIG. 5) indicating to the user that further increasing of the pressure of mattress 22 is unavailable at the present time. Notably, the pressure indicator 110 is full indicating that maximum pressure presently exists in the mattress 22, as determining according to the sensors 105. Upon reduction of the pressure in the mattress 22, the increase button 106 can be re-illuminated from its darkened state. Accordingly, the user can easily understand whether the pressure increase functionality is presently available.

Each of the buttons 46, 106, 108 can be darkened and re-illuminated in similar manner to the buttons 58 and 106 as discussed above, according to the position of the corresponding portion 24-28 or pressure of the mattress 22, as applicable. In the illustrative embodiment, the darkened button 58 is fully de-illuminated by turning off the LED backlight corresponding to the button, which may configure the button 58 to be substantially invisible as deadfronted, which may be particularly low visibility in low ambient light or dark room conditions. Accordingly, deadfronting includes that when some or all of the icons in a user interface disappear from view as a result of being de-illuminated, a deadfront effect results in which the panel appears to the user as having a monochromatic surface. More generally, a deadfront effect results in a panel where one or more of the icons appear to the user as having particularly low visibility, ultimately are invisible or substantially so. Optionally, a deadfront effect may include use of reduced illumination, darkening, complete de-illumination, and/or a generally flat surface.

However, in some embodiments, darkening to indicate unavailability of the corresponding function may include reduced illumination (dimming, for example, lowering illumination from 100% to 75% illumination, or lower such as 50% or 25%), and/or changing the color of the LED backlight to another dimmer color, for example, from white/blue/green to a dimmer color such as red or orange. In some embodiments, the extent of reduced illumination may be determined according to the amount of ambient light, for example, such that under darker ambient light conditions, darkening buttons reduces their illumination to a lower percentage than darkening buttons under brighter ambient light conditions.

In the illustrative embodiment, determination of the position of bed features, such as the deck 20 and mattress 22, at their maximum or minimum extents is performed by the control device 64 based on information from one or more of the sensors 66, 78, 80, 105, but in some embodiments, the determination of the position of bed features at their maximum or minimum extents of bed features may include consideration of other sensors and/or devices, directly or indirectly, for example, the position motors 82, 84, 86, 88 may include sensors indicating their relative position throughout their range of operation, including but not limited to, potentiometers, limit switches, and/or stop position sensors.

Referring still to FIG. 5, the interface device 30 includes other buttons 112. The other buttons 112 illustratively include room light increase and decrease buttons 114, 116, television on/off toggle button 118, television channel 124 and volume buttons 120, closed captioning button 126, mute button 128 for user selection to provide associated operation via communication connection of the bed 12 with the appropriate room control system. The interface device 30 includes a nurse call button 130 for triggering a request through a nurse call system of the care facility, for example, through a communication connection of the bed 12 with the nurse call system. A call cancel button 131 is presently unavailable because no nurse call request has been made, but is made available upon activation of the nurse call button 130 to cancel a pending call. A bed exit button 133 is shown as presently unavailable, but upon its availability, activation can provide a single button to initiate repositioning of the patient bed 12 for preferred exit position.

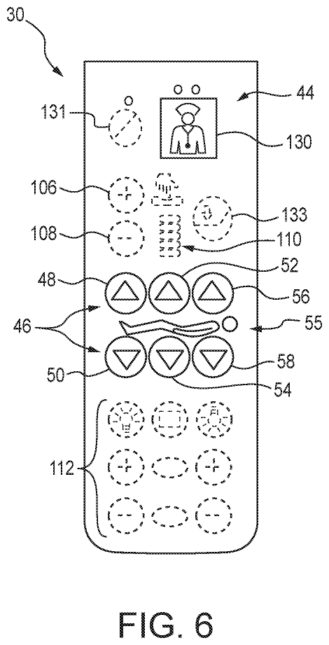

As shown in FIG. 6, the buttons 46 are all illuminated indicating that their corresponding function is available, while the mattress buttons 106, 108 and other buttons 112 are darkened indicating their unavailability. In the illustrative embodiment of FIG. 6, the interface device 30 is connected to a patient bed which does not have adjustable mattress control, or other functions (for example, a pressure control style of mattress is not installed), and thus the darkening of the mattress buttons 106, 108 and other buttons 112 avoids false indication to the user of these functions as available. Accordingly, the interface 30 can be applied to patient beds having varying degrees of adjustability without requiring a customized interface device in order to avoid miscommunication with the user.

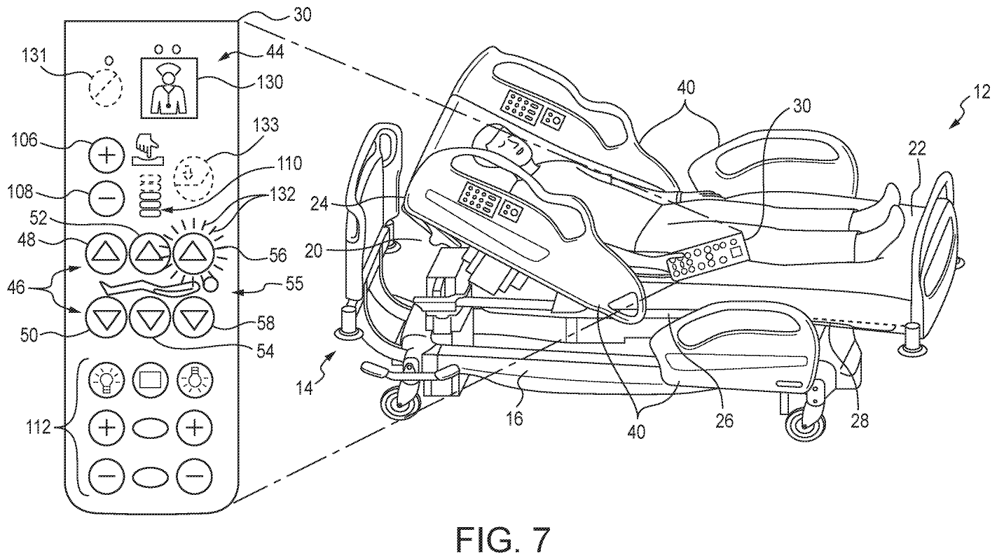

Referring now to FIG. 7, the interface device 30 can communicate recommended bed operations. The buttons 46, 106, 108 can be colored and/or blinked to encourage the user to arrange the bed 12 in preferred positions according to care regimes. Coloring and/or blinking is illustratively perform by instruction from the control system 62. By way of example, the head portion 24 of the deck 20 of the bed 12 as shown on the right side of FIG. 7, is slightly inclined, however, a preferred position of the bed 12 includes greater inclination of the head portion 24 than presently effected.

Accordingly, the inclination increase button 56 for the head portion 24 is blinked, as indicated by blinking lines 132, to draw the user's attention to the button. In some embodiments, the button corresponding to the direction of desired bed operation to re-enter preferred positioning ranges may be colored to encourage use, such as coloring the inclination button 58 green instead of the standard illumination color (e.g., white), and/or the button providing motion opposite from the direction of desired bed operation may be colored to discourage use, such as coloring the decline button 56 red.

In the illustrative embodiment, darkening of the buttons occurs on reaching a bed operational limit as a maximum or minimum of the extent of operation of the particular corresponding portion of the bed 12. However, in some embodiments, darkening of buttons may occur upon reaching preferable operational limit of the particular corresponding portion of the bed 12, for example, an inclination of the head portion 24 below the maximum extent possible by the head portion 24, but at a preferred maximum according to the care regime of the patient. For example, a patient having upper respiratory issues may preferably maintain an inclination of the head portion 24 within a preferred range, e.g., 15 to 20 degrees from horizontal, within the maximums of inclination of the head portion 24, e.g., 0 to 95 degrees.

In such instances, the caregiver may set the preferable range, via communication with the control device 64, by selecting the appropriate care regime, and the control device 64 may communicate with the interface device 64 to provide darkening of buttons according to the preferable operational limits of the head portion 24 of 15-20 degrees from horizontal. For example, upon the head portion 24 reaching the preferable maximum of 20 degrees from horizontal, the inclination button 56 may be darkened to give the impression of unavailability of further inclination of the head portion 24. If under this care regime setting, the head portion 24 exceeds 20 degrees inclination, the decline button 58 can be pulsed and/or colored to encourage declining the head portion 24 back to within the preferred 15-20 degree from horizontal range. Pulsing can include gradual increasing and decreasing illumination sequentially, and may be embodied as flashing (i.e., binary switching on and off). Upon lowering of the head portion 24 below 20 degrees, the inclination button 58 can be re-illuminated and pulsing of the decline button 56 can cease. Preferable operational limits may be equally applied to other portions 26, 28 and/or the pressure of mattress 22, according to a desirable care regime to provide corresponding indication to the user via the interface device 30.

In some embodiments, the care giver may set lock out limits to the adjustable positioning of the bed 12. For example, inclination of the head portion 24 may be limited to a preferred maximum below the operational extent of the bed 12, such that further operation of the inclination button 58 beyond the preferred maximum is locked out and the motor 82 does not respond to instructions to exceed the preferred maximum. Achievement of such lock out limits can be communicated to the user by darkening the corresponding button on the interface device 30.

The care regime including lockout limits and/or preferred operational limits are illustratively set by the caregiver as appropriate based on the patient's particular care needs. The caregiver illustratively provides settings by communication with the control device 64 via an interface which is embodied as the graphical display screen 92 as a touch screen, however, in some embodiments, may include the interface devices 30, 42 and/or remote terminals in communication with the patient bed 12, for example, a remote computer of the care facility. In some embodiments, operation of a button may be completely locked by the care giver, for example, by holding a lock button while simultaneously pressing one of the buttons 46, 106, 108.

In the illustrative embodiment, the limits of operation of each individual bed feature, such as the individual head and foot portions 24, 28 and/or mattress pressure have been presumed to be equally distinct. However, in some embodiments, the limits of operation of a given portion 24-28 and/or mattress pressure may be defined, at least in part, according to the current position of other portions 24-28 and/or mattress pressure. For example, the range of operable inclination angle of the head portion 24 may be dependent on the present extent of inclination of the foot portion 28 and/or present mattress pressure. Similarly, the preferable limits of operation of a given portion 24-28 and/or mattress pressure may be defined, at least in part, according to the current position of other portions 24-28 and/or mattress pressure.

The operational descriptions of the buttons 46, 106, 108 of the interface device 30 is applicable to the interface devices 42 such that user confusion regarding available and/or preferable bed operation can be reduced. Accordingly, the buttons of the interface device 42 of the side rails can include darkening of their buttons based on corresponding limits of bed operation.

Referring to FIG. 3, the patient bed 12 may include additional informational features as part of or in communication with the control system. For example, side rail position sensors 66 and or load cells 66 may assist the control device 64 in determining operational positions and/or states of the patient bed 12 to inform the position determinations for bed operation.

In the illustrative embodiment, the control device 64 performs bed operations including determining positions of the patient bed at thresholds whether minimum/maximum or preferred or lockout limits, and communicates to the interface device 30 to provide desirable operation of the light source 60 to appropriately illuminate buttons. However, in some embodiments, the control device 64 may include a controller for receiving indication of the bed position, determining and executing the appropriate illumination of the buttons.

In the illustrative embodiment, the interface device is formed as a control interface of a patient bed. However, in some embodiments, the interface device made be formed as a control device for any suitable manner of patient support, for example but without limitation, a surgical patient support such as a table or platform having movable deck features, such as overall deck height, torso height, leg drop angle, Trendelenburg angle, longitudinal tilt angle, lateral rotation angle, and/or any other suitable movement and/or adjustable structure features. In such embodiments, the interface device may be formed to include buttons for operating the adjustable (movable/controllable) features of the patient support, such as increasing and/or decreasing overall deck height, torso height, leg drop angle, Trendelenburg angle, longitudinal tilt angle, lateral rotation angle, increasing and/or decreasing heat and/or cooling, increasing and/or decreasing mattress and/or cushion pressure, and/or any other suitable movement and/or adjustment features. Suitable examples of adjustable surgical patient support with which the methodologies of the interface device can be applied is disclosed within U.S. patent application Ser. No. 16/275,728, filed on Feb. 14, 2019, the contents of which are incorporated by reference herein, in their entirety, including but without limitation, those portions directed to patient support adjustment features. The buttons of the interface device can be darkened (e.g., deadfronted) according to the operational limits of the particular patient support, for example, extent of movement of the movable features, including preferred limitations set according to the patient's care and/or surgical regime, and/or the availability of the corresponding movement of the particular patient support, such that darkening of a particular button occurs if the patient support is not presently equipped for the movement corresponding to the particular button. In some embodiments, the surgical support may include adjustable environmental features, for example, heating and/or cooling features (e.g., thermoregulation via air/liquid, blankets), and/or pressure controllable surgical mattresses or cushions. In such embodiments, the buttons of the interface device can be darkened (e.g., deadfronted) according to the operational limits of the particular patient support, for example, the pressure limits and/or thermoregulation limits of the particular patient support equipment, including preferred limitations set according to the patient's care and/or surgical regime, and/or the availability of the corresponding operation of the particular patient support, such that darkening of a particular button occurs if the patient support is not presently equipped with the operation (e.g., thermoregulation and/or mattress pressure control) corresponding to the particular button.

Although certain illustrative embodiments have been described in detail above, variations and modifications exist within the scope and spirit of this disclosure as described and as defined in the following claims.

We claim:

1. A patient bed, comprising:
a bed frame for supporting a patient above the floor, the bed frame including a deck including head, knee, and foot portions for supporting corresponding portions of the patient's body, wherein the deck is selectively positionable to accommodate positioning of the patient's body;
a control system including at least one actuator coupled with the bed frame for selectively positioning the deck according to user selection; and
an interface device arranged in communication with the control system to provide selective positioning of the deck, the interface device including a number of buttons for user selection to selectively position the deck, and at least one light source for illuminating the number of buttons, wherein the at least one light source is configured to darken selective ones of the number of buttons responsive to the position of the deck reaching at least one predetermined threshold.

2. The patient bed of claim 1, wherein at least one of the head, knee, and foot portions of the deck is positionable between maximum and minimum positions.

3. The patient bed of claim 2, wherein the at least one predetermined threshold includes the maximum position of at least one of the head, knee, and foot sections of the deck.

4. The patient bed of claim 3, wherein, at the maximum position of the at least one of the head, knee, and foot sections of the deck, the at least one light source darkens at least one of the number of buttons which corresponds to adjustment of the at least one of the head, knee, and foot portions of the deck in a direction beyond the maximum position.

5. The patient bed of claim 4, wherein the at least one light source is configured to illuminate the at least one darkened button responsive to the position of the at least one of the head, knee, and foot portions of the deck being arranged at a position less than the maximum.

6. The patient bed of claim 5, wherein illuminating the at least one button includes revealing the at least one button.

7. The patient bed of claim 4, wherein darkening the at least one button includes hiding the at least one button.

8. The patient bed of claim 2, wherein the at least one predetermined threshold includes the minimum position of at least one of the head, knee, and foot sections of the deck.

9. The patient bed of claim 8, wherein, at the minimum position of the at least one of the head, knee, and foot sections of the deck, the at least one light source darkens at least one of the number of buttons which corresponds to adjustment of the at least one of the head, knee, and foot portions of the deck in a direction below the minimum position.

10. The patient bed of claim 9, wherein the at least one light source is configured to illuminate the at least one darkened button responsive to the position of the at least one of the head, knee, and foot portions of the deck being arranged at a position greater than the minimum position.

11. The patient bed of claim 10, wherein illuminating the at least one button includes revealing the at least one button.

12. The patient bed of claim 9, wherein darkening the at least one button includes hiding the at least one button.

13. The patient bed of claim 1, wherein the at least one predetermined threshold is set according to the patient's care regime.

14. The patient bed of claim 13, wherein the at least one predetermined threshold is set to include a preset angle of inclination of the head portion of the deck such that responsive to the head portion reaching at least the preset angle of inclination of the head portion, the light source darkens the one of the buttons corresponding to increasing head portion inclination.

15. The patient bed of claim 14, wherein the preset angle of inclination is an upper limit that is set according to the patient's care regime, and responsive to positioning of the head portion at least at the preset angle of inclination of the head portion, the at least one light source pulses the one of the buttons corresponding to decreasing head portion inclination, to suggest lowering of the inclination of the head portion.

16. The patient bed of claim 14, wherein the preset angle of inclination is a lower angle set according to the patient's care regime, and responsive to positioning of the head portion at least at the preset angle of inclination of the head portion, the at least one light source pulses the one of the buttons corresponding to increasing head portion inclination, to suggest raising of the inclination of the head portion.

17. The patient bed of claim 1, wherein the predetermined threshold includes at least one of a lower and an upper deck height.

18. The patient bed of claim 17, wherein at least one of the lower and the upper deck height is a recommended threshold set according to the patient's care regime.

19. The patient bed of claim 17, wherein responsive to positioning of the deck at least at the upper deck height, the at least one light source darkens at least one button which corresponds to increase of the deck height.

20. The patient bed of claim 19, wherein responsive to positioning of the deck at least at the upper deck height, the at least one light source pulses at least one button which corresponds to decrease the deck height, to suggest returning the deck to a position below the upper deck height.

21. The patient bed of claim 1, wherein the predetermined threshold includes at least one of a lower and an upper foot portion height.

22. The patient bed of claim 21, wherein at least one of the lower and the upper foot portion height is a recommended threshold set according to the patient's care regime.

23. The patient bed of claim 21, wherein responsive to positioning of the foot portion at least at the upper foot portion, the at least one light source darkens at least one button which corresponds to increase of the foot portion height.

24. The patient bed of claim 23, wherein responsive to positioning of the foot portion at least at the upper foot portion height, the at least one light source pulses at least one button which corresponds to decrease the foot portion height, to suggest returning the foot portion to a position below the upper foot portion height.

25. The patient bed of claim 21, wherein responsive to positioning of the foot portion at least at the lower foot portion, the at least one light source darkens at least one button which corresponds to decrease of the foot portion height.

26. The patient bed of claim 25, wherein responsive to positioning of the foot portion at least at the lower foot portion height, the at least one light source pulses at least one button which corresponds to increase of the foot portion height, to suggest returning the foot portion to a position above the lower foot portion height.

27. The patient bed of claim 1, further comprising a mattress supported on the deck for interface with the patient's body, the mattress including at least one pressurizable chamber for receiving pressurized fluid.

28. The patient bed claim 27, wherein the predetermined threshold includes at least one of an upper and lower mattress pressure, and the number of buttons includes buttons for increasing and decreasing the mattress pressure.

29. The patient bed of claim 28, wherein responsive to the mattress pressure being at least at the upper mattress pressure, the at least one light source darkens at least one button which corresponds to increase of the mattress pressure.

30. The patient bed of claim 29, wherein responsive to the mattress pressure being at least at the upper mattress pressure, the at least one light source pulses at least one of the number of buttons which corresponds to decrease of the mattress pressure, to suggest returning the mattress pressure below the upper mattress pressure.

31. The patient bed of claim 27, wherein responsive to the mattress pressure being at least at the lower mattress pressure, the at least one light source darkens at least one button which corresponds to decrease of the mattress pressure.

32. The patient bed of claim 31, wherein responsive to the mattress pressure being at least at the lower mattress pressure, the at least one light source pulses at least one of the number of buttons which corresponds to decrease of the mattress pressure, to suggest returning the mattress pressure above the lower mattress pressure.

33. The patient bed of claim 1, wherein the interface device includes a bed pendant.

34. The patient bed of claim 1, wherein the interface device includes a side rail control panel.

35. The patient bed of claim 1, wherein the interface device includes an interface panel having the number of buttons disposed on the interface panel, wherein the at least one light source is arranged within the interface panel to backlight the buttons.

36. The patient bed of claim 1, wherein the at least one light source includes light emitting diodes.

37. The patient bed of claim 1, wherein the at least one light source includes one light emitting element for each of the number of buttons.

38. The patient bed of claim 1, wherein darkening selective ones of the number of buttons includes changing color of illumination of the selective ones.

39. The patient bed of claim 1, wherein darkening selective ones of the number of buttons includes imposing a deadfronting effect.
